(19) United States
(12) Patent Application Publication
(10) Pub. No.: US 2023/0389743 A1
(43) Pub. Date: Dec. 7, 2023

(54) COFFEE BEVERAGE BREWING EXTRACTION METHOD AND APPARATUS USING STIRRING FORCE

(71) Applicants: Kang Hoon LEE, Yongin-si Gyeonggi-do (KR); Bum Ho LEE, Yongin-si Gyeonggi-do (KR)

(72) Inventors: Kang Hoon LEE, Yongin-si Gyeonggi-do (KR); Bum Ho LEE, Yongin-si Gyeonggi-do (KR)

(21) Appl. No.: 18/250,773

(22) PCT Filed: Nov. 2, 2021
(86) PCT No.: PCT/KR2021/015710

§ 371 Date: Apr. 27, 2023

(30) Foreign Application Priority Data
Nov. 3, 2020 (KR) 10-2020-0145579
Nov. 23, 2020 (KR) 10-2020-0158251
Dec. 7, 2020 (KR) 10-2020-0169697
Dec. 29, 2020 (KR) 10-2020-0186842

(51) Int. Cl. A47J 31/22; A47J 31/06; A47J 31/44

(52) U.S. Cl. CPC A47J 31/22; A47J 31/0631; A47J 31/4403

(57) ABSTRACT

The present disclosure relates to a coffee beverage extractor of a hand-drip type, and to a simple and convenient coffee beverage extraction method and apparatus, wherein, to reduce filter clogging and shorten the extraction time, by installing an improved dripper having a stirring function applied thereto, a coffee beverage can be quickly extracted at an espresso level from finely ground coffee beans, and a coffee beverage with deep flavor and increased extraction efficiency can be brewed from compressed coffee bean blocks and different types of ground coffee beans.

### BACKGROUND

### Field

The present disclosure relates to a coffee beverage extraction method and apparatus with increased efficiency by applying a simultaneous immersion and extraction hand drip method and rotational force to increase an extraction area and extraction efficiency of a filter, and more particularly, to a coffee beverage extraction method and apparatus for shortening extraction time by expanding a filter area in contact with water when water is applied to finely ground coffee beans and compressed coffee bean blocks to extract a coffee beverage, increasing extraction efficiency by using stirring function, centrifugal force, and gravity, and enhancing flavor of the coffee beverage.

### Related Art

There are various methods of extracting a coffee beverage by adding water to coffee beans. Drip methods, such as an espresso extraction method, a traditional hand drip method, a pour-over hand drip method, and an immersion type hand drip method, a cold brew extraction method, and a brewing method have been developed in various ways to enhance the flavor of coffee and improve extraction efficiency.

As for the flavor of coffee beverages, coffee beverages with good flavor can be extracted when the quality of green coffee beans is high, and the roasting degree of coffee beans, the degree of grinding, the extraction method, the extraction time, and the temperature of water affect the flavor.

Recently, a method of extracting water-soluble coffee solids by making coffee beans into compressed blocks by applying constant pressure to coffee beans without grinding the coffee beans and allowing water to permeate between cracks generated in coffee beans during the compression has been introduced. However, there is not disclosed an efficient extraction method for coping with filter clogging and surfaces of the coffee beans less cracked during the compression.

All extraction methods have pros and cons, and coffee beverages are extracted by selecting according to individual tastes.

Among the above extraction methods, the hand drip method is a method using the simplest mechanism, which extracts a coffee beverage by placing filter paper on a dripper and adding water to ground coffee beans or compressed coffee bean blocks through the filter paper, and the core of the hand drip extraction method is to ensure that in the extraction process, water and coffee beans meet in harmony to extract only coffee soluble solids and to prevent bad taste from being extracted from fibers of the beans. However, there are many variables such as water pouring by a person to extract, extraction time control, and size distribution of coffee beans, and filter paper that acts as a filter during extraction is clogged by fibers such as coffee cell walls, which results in a significant amount of time for coffee beverage extraction and thus a great influence on extracting coffee flavor and sufficient coffee beverage amount.

In order to produce a rich taste of coffee, coffee beans need to be finely ground, but the filter is clogged by the finely ground fibers, which lengthens the extraction time. Further, due to the fine fiber structure and the increased contact area with water, a lot of bad taste such as burnt taste is extracted from resin components of the fiber, and if the size of the ground beans is increased, a coffee beverage with a plain flavor is extracted.

In the present disclosure, in order to extract a coffee beverage with a rich flavor, the simultaneous immersion and extraction method is applied to a hand drip method that can be easily used with a general simple structure, the area of the filter in contact with a mixed solution of coffee beans and water staying in the dripper during extraction is enlarged, and centrifugal force and gravity, stirring ability work harmoniously.

In general, there are various coffee beverage extraction methods, but the final goal thereof is basically to extract a large amount of water-soluble coffee solids in a honeycomb cell structure of coffee beans and to prevent extraction of a honeycomb cell wall and a woody part (fiber resin component) of the bean skin.

The resin component in the fibrous structure has a bad effect on the flavor of coffee beverages, such as burnt taste and impure taste, so when extracting coffee beverages, if the coffee beans are finely ground or if the extraction time is long, the resin component is over-extracted, resulting in a lot of impute taste such as bad bitter taste mixed with unnecessarily burnt taste in the coffee beverages.

Meanwhile, in the conventional hand drip methods, besides the traditional hand drip, there are pour-over type hand drip and leaching type hand drip using a clever dripper. The simple hand drip method has a difficulty of carefully controlling the pouring, and the taste changes greatly depending on each individual's skill to improve the flavor. The pour-over method has no difficulty in pouring, but the sensitive control of the flavor is poor.

The leaching-after-immersion drip method is a method in which water and coffee are mixed and immersed for a certain period of time, about 2 to 3 minutes, and then extracted at once.

All of the above methods have pros and cons, but in particular, an extraction method suitable for finely ground coffee beans and compressed blocks with fine cracks has not yet been specially developed.

According to the related art, brewing methods that use centrifugal force in an extraction method to filter a mixed solution of ground coffee beans and water through a double filter by using centrifugal force are disclosed.

Several disclosed technologies, such as Korean Patent Application No. 10-2016-0149679 (2016 Nov. 10.) ‘Coffee filtering device using centrifugal force’ and Korean Patent Registration No. 10-1719356 (2017 Mar. 17.) ‘Drip coffee machine’, etc., show examples of technology of extracting coffee using rotational force, but most of them disclose the technology of rotating a dripper so that the dripping water evenly contact ground coffee beans, and the coffee beans automatically drip, a technology related to a coffee maker that evenly sprinkles hot water onto ground coffee beans. The principle of using rotational force for coffee extraction is the same, but in the detailed mechanism thereof, in order to use the rotational force, an agitator or dripper of a rotation shaft directly connected to a motor rotates to generate stirring force, or a cylinder container containing ground coffee beans and water connected to a motor through a gear or pulley rotates to utilizes centrifugal force generated by the rotation. The structure constituting the mechanism is complicated, the mechanism is heavy to deteriorate the convenience, a fundamental method for flavor improvement of coffee beverage is not described, and the separation of the coffee extract container after extraction is poor, which makes it inconvenient to wash the container or drink the coffee beverage.

In addition, there is no method for reducing the coffee beverage extraction time, and in particular, there is no method for improving the problem when the filter is clogged by finely ground coffee, and there are a number of problems from the viewpoint of the manufacturing method or the user, such as difficulty in checking whether the major parts constituting the main mechanism are mounted in a case and operate smoothly.

### SUMMARY

An object of the present disclosure is mainly to provide a coffee beverage extraction method and device capable of increasing flavor and extraction efficiency by expanding a contact area between a mixed solution of coffee beans and water and a filter to reduce filter clogging, and efficiently stirring the beans and water during the extraction process.

An object of the present disclosure is to provide an extractor including an immersion type dripper of a new structure in which by improving a conventional immersion drip method, which is a method of extracting at once after immersion for a certain period of time, a certain ratio of water is poured into a dripper to stir the water and coffee beans for a certain period of time, and then the coffee beans and water are efficiently stirred while the coffee beverage is extracted, and a filter area can also be increased.

In particular, an object of the present disclosure is to shorten the extraction time close to an espresso extraction time through efficient application to finely ground coffee beans, and to quickly and efficiently extract coffee beverages from coffee beans ground in various grinding methods.

In addition, in order to efficiently achieve the above objects of the present disclosure, by making the coffee beans compressed evenly so that a large number of cracks are evenly generated in cell walls of a honeycomb structure constituting the coffee beans, but a smaller number of cracks are generated in a fiber structure of skins of the beans, which adversely affects the coffee taste, when compressed beans come in contact with water, the water permeates through the cracks so that water-soluble coffee solids are well extracted and less extracted from the fibrous structure such as the skin of the beans, which enables efficient extraction even when using compressed coffee beans such as compressed coffee bean blocks.

An object of the present disclosure is to be able to apply intimateness and familiarity to extraction to a user by utilizing a large part of existing various hand drip devices as they are.

An object of the present disclosure is to provide a coffee beverage flavor that can be adjusted variously by adjusting the shape and rotational force, such as an area of an extraction port of a dripper and a volume of a rotor.

An object of the present disclosure is to provide a coffee beverage brewing method and apparatus, which is easy to manufacture due to a simple structure, can be applied to franchise coffee makers or mechanisms for mass production processes, and is easy to separate for each part, making it convenient to wash and carry after use.

A coffee beverage brewing extraction method and apparatus suitable for the present disclosure is basically capable of shortening an extraction time by efficiently applying extraction time and rotational force depending on a thickness of ground coffee beans to the simultaneous immersion and extraction method by a dripper or filter to allow coffee beans and water to be efficiently stirred and mixed and by sufficiently increasing the contact area of the mixed solution of the coffee beans and water with the filter when the mixed solution of the coffee beans and water passes through the filter.

The dripper or filter described in the specification of the present disclosure uses the same reference numerals as a structure for functioning as a filter used in the extractor of the present disclosure, and depending on the purpose of use, the dripper has a function of seating and using a separate filter paper, the filter has a structure in which filter holes are formed to have a filter function.

The dripper or the filter has a space where coffee beans and water are mixed, and a rotor of various shapes capable of generating stirring force is disposed in an inner space of the dripper or the filter.

The function of the rotor is to efficiently generate the stirring force, and when the rotor has an appropriate volume of a conical shape or the like and is placed in the inner space of the dripper or the filter, the level of the mixed solution of coffee beans and water rises by the volume of the rotor, so that an area of the portion where the mixed solution contacts the filter is increased, and the clogging of the filter can be further reduced.

Preferably, the shape of the rotor is formed to have a sufficient volume, as shown in the examples shown in FIGS. 8 and 9 depending on the stirring force and purpose, so that the object of the present disclosure can be efficiently achieved.

The volume of the rotor is preferably at least 30% or more of the volume of the mixed solution when submerged in the mixed solution to increase the contact area between the mixed solution and the filter surface.

When the volume of the rotor is smaller than the above volume, the effect of rising the level of the mixed solution is reduced and sufficient filter area is not secured, and the filter clogging phenomenon occurs in the fine grinding degree of the beans, resulting in a long extraction time, whereas when the rotor volume becomes too large, there is a problem in that it is unable to sufficiently fill the mixed solution inside the dripper or the filter and it is difficult to properly maintain the temperature of the mixed solution.

Experiments have shown that the volume of the rotor is effective to allow the volume of the rotor submerged in the mixed solution when water and coffee beans are mixed in the dripper or the filter to have 30% to 80% of the volume of the mixed solution, and when the volume is greater than that, the surface area of the mixed solution increases to make it difficult to maintain the coffee beverage extraction temperature, or the dripper capacity becomes too large. Further, when stirring in a state in which the space between the outer surface of the rotor and the inner wall of the dripper or the filter is too narrow, only water is extracted through the filter surface without sufficient agitation by centrifugal force, which decreases the stirring efficiency.

As the grinding degree of the beans is fine, the increased volume of the rotor reduces the clogging of the filter and makes it possible to extract an appropriate amount of coffee beverage within the desired time, and as the coffee beans are ground to a larger thickness, the filter clogging was not so great even though the volume of the rotor was kept small.

If the volume of the rotor is larger than the upper limit of 80%, the structure of the dripper may be made as a warming structure so that the temperature of the mixed solution in the dripper or the filter can be properly maintained, or as a structure in which the outer wall surrounding the dripper or filter is filled with hot water. In a structure that maintains the temperature by properly maintaining the temperature of the outer wall of the dripper or the filter by a heating wire, by increasing the volume of the rotor and stirring in a manner that the rotation speed of the rotor is reduced, it is possible to maintain an appropriate agitation state while reducing the filter clogging.

By the above function of the rotor, the gravitational action of the mixed solution applied to the filter increases as much as the level of the mixed solution increases, and as shown in the examples of FIGS. 8 and 9, since the mixed solution in the dripper or the filter is mixed in a state where the space between the filter wall and the outer surface of the rotor is narrowed, so it passes through the filter in a more homogeneous mixed solution state even when the stirring force is small.

A coffee beverage extraction port is disposed at the bottom or lower side of the dripper to efficiently stir and extract coffee beverages remaining for a certain period of time in the inner space of the dripper 11 while the mixed solution of coffee beans and water is extracted.

The size (area) of the extraction port is appropriately adjusted according to the grinding degree of the coffee beans so that the mixed solution in the dripper stays and is stirred efficiently, and the extraction time can be controlled. If the size of the extraction port 110 is too large, the coffee beverage flows down to the undiluted solution extraction body too quickly without stirring the mixed solution efficiently in the dripper, so that the flavor of the extracted coffee beverage is not deep, and if the size (area) of the extraction port is too small, it takes a long time to extract, and the coffee beverage mixture is over-extracted, resulting in a lot of impure taste such as burnt taste.

Preferably, the size of the extraction port is preferably adjusted to suit the purpose of use such that the time for extracting the coffee beverage from the mixed solution of coffee beans and water stirred in the dripper is 1 minute to 2 minutes and 30 seconds depending on the grinding degree of the beans.

In other words, the present disclosure has a structure in which coffee beans and water are poured into the dripper and coffee beverage is extracted through the extraction port at the bottom of the dripper while stirring by the rotor, wherein stirring and extraction are performed simultaneously unlike a conventional leaching method in which extraction is performed after immersion for a certain period of time, and the extraction time is basically determined according to the capacity of the mixed solution of water and coffee beans poured into the dripper and the size (area) of the extraction port 110.

In the structure of the dripper, a rib is disposed on the inner wall of the dripper so that when a paper filter or a cotton flannel filter is seated on the inner wall of the dripper, an air flow space is secured by the rib 113 so that the coffee beverage extracted along the inner wall of the dripper can flow through the air flow space.

The structure of the dripper and the rib may be manufactured in the same or similar structure as various conventional drippers, but it is preferable to have a dripper structure with a fast water flow. The rib arrangement may be made in an appropriate shape according to the purpose, and the overall shape of the dripper may have various dripper structures such as a conical shape, a conical polygonal shape, and a polygonal cylinder shape. The dripper may have a structure with a large surface area to volume in order to increase the filter area.

The dripper may be manufactured with a vacuum structure between the inner wall and the outer wall according to the principle of a conventional thermos bottle in order to maintain the extraction temperature by strengthening the warming function.

The dripper may have a structure capable of maintaining warmth by securing a space for filling the outer wall of the dripper with hot water and maintaining warmth by heating wires around the outer wall of the dripper.

The coffee beans and water are efficiently stirred by appropriate transmission power, water waves, vibration, air bubbles generated in water, and gravity applied to the coffee beans when the coffee beans and water are maintained or efficiently stirred in a mixed solution state by the rotor 12 for the extraction time depending on the arrangement in the top and bottom spaces such as the shape of the dripper, the rib structure, the volume of the rotor, and the like.

While the coffee beans and water are stirred and the coffee beverage is simultaneously extracted, by some centrifugal force generated by the rotor and the gravity due to the height of the mixed solution, the coffee beverage is extracted through the filter along the inner wall of the dripper, and flows down through the extraction port disposed at the bottom of the dripper to the undiluted solution extraction body unit.

In the present disclosure, the stirring force needs to be efficiently generated depending on the grinding degree of the beans and the cracked degree of the compressed bean blocks. In the case of finely ground coffee beans of around 0.2 mm in size for espresso, light coffee beans are spread evenly in the water during the process of being mixed with water, and it takes some time for the coffee beans to sink to the bottom of the water. Therefore, the stirring force at this time is sufficient when a little stirring force is enough not to sink the bean powder, and it is preferable to sufficiently generate the stirring force as the size of the ground bean particles increases and as the cracks of the compressed blocks are generated less.

The total area of the extraction port disposed in the dripper is set such that when only water is poured into the dripper of a capacity of 300 ml, the time for the water to flow down is typically 1 minute or more, but it is preferable to set a standard time within 2 minutes and 30 seconds.

When extracting a coffee beverage from finely ground coffee beans for espresso or mocha pot, by adjusting the area of the extraction port to have a shorter extraction time than the typical standard time of 1 minute so that the extraction is completed quickly, it is possible to prevent the fibers of the fine coffee beans from being over-extracted.

In addition, when extracting from blocks with less cracks among the compressed bean blocks or ground beans with a large thickness, even if the extraction standard time is adjusted to be slightly longer than 2 minutes and 30 seconds, the bean skin fibers are remained large due to the structure of the compressed bean blocks, which prevents bad taste extraction.

According to experiments, if the extraction time is shorter than the above-specified extraction time, sufficient flavor is not extracted from the beans, and if the extraction time is longer than the above-specified extraction time, bitter taste and impure taste such as burnt taste from fibers such as cell walls are brewed a lot due to over-extraction.

When the capacity of the dripper is larger than the above reference capacity to increase the coffee beverage extraction amount, it is preferable to increase the total area of the extraction port 110 so that the total extraction time is not significantly different from the above reference time in order to maintain the flavor of the coffee beverage

When it is necessary to adjust the area of the extraction port, the area of the extraction port can be adjusted by installing an extraction port area adjusting unit 114 having a structure that can contact and rotate the lower extraction port of the dripper, or can be properly adjusted through a hole adjustment method by installing an adjustment valve or installing a pivot screw.

Even when using a filter having its own filter holes disposed on an outer wall of a dripper structure as a substitute for the dripper, it is preferable that the filter holes are provided in the filter under the above conditions so that the mixed solution of water and coffee beans can stay in the filter for a certain period of time and be stirred by the rotor.

Depending on the size and arrangement of the filter holes, the extraction time through the filter can be adjusted.

In order to properly maintain the temperature of the filter, a double structure wall into which hot water can be poured may be installed on the outer wall of the filter like the dripper, and the temperature may be maintained by maintaining the temperature around the outer wall of the filter with a heating wire.

Due to the nature of the filter, some of the fine fibers pass through the filter or the coffee fat is not filtered out, so it goes without saying that the dripper or the filter may be selected and used according to the user's taste.

In general, the conventional hand drip method or the drip method using an appliance such as a coffee maker has a structure that ground coffee beans are concentrated in the lower part of the filter, and when water is poured on the coffee beans, the extraction is made only through the filter area portion where the filter and coffee beans come into contact.

On the other hand, in the method of the present disclosure, coffee beans and water are appropriately poured into the dripper or the filter so that the mixed solution is filled up to a significant portion of the dripper, and as a result, the total area of the filter in the dripper or the filter in contact with the mixed solution becomes the area where the extraction is made through the filter, and the extraction area increases.

Furthermore, the extraction area is increased with the structure in which the filter area in contact with the mixed solution is increased by a level rising by the appropriate volume of the rotor disposed inside the dripper or the filter to perform the stirring action.

According to the present disclosure, in the case of finely ground coffee beans of about the size of espresso, stirring can be performed within a short time, and the extraction filter area is increased to significantly reduce filter clogging, so the extraction time can be shortened to a level similar to that of espresso.

In addition, since the mixed solution is stirred and extracted simultaneously, in terms of the overall structure of the dripper, the solids giving a good taste that are extracted at the beginning are extracted a lot in a state where the contact filter area is wide as a whole, while the extraction amount of bad tastes such as impure taste, excessive bitter taste, etc., is reduced later since the extraction area is smaller than the first.

Therefore, the extraction method of the present disclosure can extract a coffee beverage with a deep flavor in a short time.

A coffee beverage brewing extractor 1 using a stirring force suitable for the present disclosure includes a coffee beverage extraction unit 10 and a holding unit 20 located above or below the extraction unit.

The coffee beverage extraction unit 10 has a server shape with a container function as a whole, and includes a dripper 11 having a server function undiluted solution extraction body 13 and an extraction port or a filter 11 having its own filter function, and a rotor 12 that is disposed in an inner space of the dripper or the filter, receives rotational force or agitation force from external force by a rotating part 21 or a hand motion, and generates agitation force and centrifugal force in the compressed coffee bean blocks or the mixed solution of compressed and ground coffee beans and water put into the dripper 11.

The rotor 12 may be directly rotated by a user by installing a handle 50 at a portion connected to a rotation shaft 40 as shown in FIG. 8, or may be rotated by rotational force transferred through a magnetic force or the rotation shaft from the rotating part 21 located above or below the dripper or the filter. The rotor serves to stir the coffee beans and water in the dripper or the filter 11 by the rotational force of the rotor and to form a centrifugal force at the same time, and has a conical shape, a ring shape, a wing shape, a rod shape, etc. made of materials such as plastic, metal, and wood, and has a certain volume suitable for the arrangement space or purpose, and is set to generate the best stirring force depending on the grinding state of coffee beans.

When the rotor 12 is operated by a motor or a handle, it can be rotated at an appropriate rotation speed by arranging a gear, and rotates by receiving rotational force by magnetic force from the rotation part 21 by the motor in the same principle as a magnetic stirrer. Further, depending on the purpose, the rotor can be rotated by the rotating part 21 and a coupling 30 that are physically transmitted in the same principle as a mixer, or can be directly connected to the motor rotating part 21 and rotated.

When a rotor with a small volume such as a ring is disposed on a bottom portion of the dripper or the filter in a magnetic stirrer method to stir, the rotor having a certain volume in the mixed solution inside the dripper or the filter is fixed to a lid of the extractor so that it is submerged in the mixed solution when the lid is closed similarly to the example shown in FIG. 9, it can function to raise the level of the mixed solution.

Depending on the purpose, a rotor having sufficient volume may be fixed to the lid or the like in a structure similar to the illustrated example of FIG. 9 to stir the mixed solution by only a user's hand motion during dripping, or the coffee beverage extraction unit 10 may receive vibration or rotational force from an external device to generate stirring force.

When the rotor 12 rotates, the coffee beans and water in the dripper or the filter 11 are efficiently stirred and appropriate centrifugal force is generated so that the coffee beans pass through the filter of the dripper 11 through the extraction port or through the filter. Accordingly, the coffee beverage of the water-soluble component of the coffee beans mixed with water is extracted out of the dripper or the filter 11 and collected in the undiluted solution extraction body 13.

In particular, as shown in FIG. 8, when the rotor 12 has a structure that has a certain volume of a conical shape or the like and is disposed in the inner space of the dripper or the filter and driven, the level of the mixed solution of coffee beans and water is increased by the volume of the rotor submerged. As a result, the contact area between the filter and the mixed solution can be increased.

Since filter clogging can be further improved by the above function, when it is necessary to widen the filter area in contact with the mixed solution, the rotor may be configured in a shape that gives an appropriate volume, and the surface of the rotor may be configured by arranging various spiral shapes or stripe shapes in a complex manner to effectively deliver stirring force and waves to the mixed solution.

In view of overall structure, the undiluted solution extraction body 13 may include a protrusion part 15 having a cylindrical shape or a trapezoidal column shape having a certain height from the lower bottom surface when using a magnetic stirring type rotor, and a lower part of the protrusion part 15 is open and connected to an outer circumferential surface of the bottom open in the same area at the center of the undiluted solution extraction body 13 while an upper part of the protrusion part 15 is blocked. The upper part of the protrusion part 15 has a structure to which the dripper or the filter 11 can be seated, and preferably has a flat structure in which a magnetic force of the rotating part 21 can be well transmitted to the rotor 12 located below the dripper or the filter 11 when the principle of the magnetic stirrer is applied.

In all embodiments of the present disclosure, a handle 14 and a lid may be added to an upper portion of the undiluted solution extraction body 13.

When the protrusion part 15 has a certain height as described above, when the coffee beverage extracted from the dripper or filter 11 is collected in the lower part of the undiluted solution extracting body 13, due to the difference in height of the dripper or the filter 11, the extracted coffee beverage collected in the undiluted solution extraction body 13 is prevented from contacting the dripper or the filter 11, and it is possible to prevent contact between coffee beans and water being filtered in the dripper or filter 11 and the extracted coffee beverage. Further, when the coffee beverage is extracted by the filter 11, the protrusion part 15 may function to facilitate gravity action.

The desired function of the present disclosure can be efficiently achieved due to the characteristics of the above structures, but the height of the protrusion part 15 may be lowered or increased, and the height may be completely eliminated so that the lower surface of the undiluted solution extraction body 13 is flat to seat the filter on the lower flat surface of the undiluted solution extraction body, which can be selected to utilize the present disclosure for the purpose of use.

In particular, the main object of the present disclosure can be achieved by reducing the volume of the coffee beverage extracting unit 10 while increasing the amount of coffee beverage extraction or by appropriately adjusting the height of the protrusion part 15 for convenience in manufacturing.

The dripper or the filter 11 functions as a filter by installing a paper filter or the like to prevent dregs such as coffee cell walls from being extracted out of the dripper or the filter 11 when coffee beverage is extracted, or by forming filter holes in the body wall of the filter itself, and when the stirring force and the centrifugal force are applied by the rotor 12, only the coffee beverage is extracted for a certain period of time and flows out of the filter 11 through the extraction port of the dripper or the filter holes in the wall of the filter itself. As such, the filter is configured to perform the filter function smoothly by appropriately forming small holes through which powders such as coffee cell walls cannot pass in a material such as stainless.

In addition, for convenience of use, the dripper 11 is made by forming an extraction port of an appropriate size to a material such as metal, plastic, ceramics, etc., and the dripper 11 is used by seating a paper filter, a melt filter, etc. thereon whenever the dripper 11 is used.

The dripper may be manufactured in a structure in which a filter net made of metal or synthetic resin is installed on the inner wall of the dripper.

The material of the filter 11 may be selected from a variety of materials, such as a combination of a mesh-shaped wire mesh or a mesh made of synthetic resin in addition to metal materials such as stainless, or a pottery or ceramic material with appropriate pores.

The filter 11 separates a section in which the filter holes are formed, so that an upper part 111 has no hole and only a lower part 112 may have holes, or by separating several sections, a section in which holes are formed and a section in which holes are not formed may be alternately arranged.

This is to adjust the extraction time by adjusting the extraction area from the coffee beans and water mixed in the filter 11 and to properly secure the filter area in contact with the mixed solution.

This is to adjust the extraction time by adjusting the extraction time depending on the purpose of use, such as the grinding degree of various beans, and the purpose can be achieved through the selection of the filter 11 in which the upper area and the lower area are appropriately or alternately arranged.

The holding unit 20 is connected to the undiluted solution extraction unit 10 and may include a rotating part 21 composed of a motor for transmitting magnetic rotational force to the rotor 12, an adjuster 22 for adjusting rotational force such as a rotation speed, and various hot wires 23 for maintaining the temperature of the coffee beverage extracted in the undiluted solution extraction unit 10 or the dripper (not shown) at a constant temperature.

The holding unit 20 has a round table shape as a whole, and a power supply unit for supplying power to the rotating part 21 and a control circuit for controlling the motor speed are included in the holding unit 20, and a timer linked to the rotating unit to allow the rotating unit to operate for a certain period of time may additionally be installed in the holding unit 20.

In the case of the magnetic stirrer type, the holding unit 20 has a shape of the protrusion part 15 that matches the shape of the coffee beverage extraction unit 10 at the upper end of the holding unit 20, and the rotating part 21 is disposed inside the protrusion part 15 so that the rotational force is well transmitted to the rotor 12 disposed at the bottom of the dripper or the filter 11.

The rotating part 21 is an electric motor when power is used, and on the top of the rotation shaft of the electric motor, a disc 221 with a magnet attached perpendicularly to the shaft or a linear magnet perpendicular to the shaft is installed so that the rotational force of the rotating part 21 is applied to the rotor 12. The rotor 12 has an appropriate ring structure, wing structure, and straight bar structure, but may be used by attaching a magnetic material with good magnetic force to each shape of the rotor 12 or by coating the magnetic material with Teflon or the like.

In case that the magnetic stirrer method is not adopted, the rotating part 21, the adjuster 22, the control circuit, etc. to be installed in the holding unit may be disposed above the dripper or the filter, and the rotation shaft of the rotating part 21 may move the rotor 12 positioned in the inner space of the dripper or the filter.

As shown in FIG. 7 or 8, in the method of disposing the rotating part 21 above the dripper or the filter, the rotating part 21 or a handwheel is installed on the lid or the top of the extractor, and the rotating part 21 or the handwheel is connected to the rotor 12 to rotate the rotor 12. The shape of the rotor 12 may be selected in various ways such as conical, cylindrical, wing-shaped, ring-shaped, rod-shaped, or mixed type, and as shown in FIG. 8, the shape of the rotor 12 may be selected to have an appropriate volume so that the coffee beans and water can be well stirred when the rotor rotates.

A speed controller 22 and a control unit may be connected to the rotating part 21 to control the rotating part 21 to be suitable for various extraction conditions.

When the rotation shaft is directly connected or connected through gears to the rotor to rotate the latter, the dripper or the filter may be placed over a curved part of an upper neck portion of the undiluted solution extraction body 13 as shown in FIGS. 7 and 8 to be used.

Depending on the structure, when applied to a coffee maker machine structure, the set configuration of the dripper or the filter and the rotating part 21 may be separated from the server container functioning as the undiluted solution extraction body 13 and separately arranged vertically.

The coffee beverage brewing extraction apparatus according to the present disclosure is applied to various types of coffee beans such as finely ground coffee beans and compressed blocks, so that the flavor is deep, the extraction efficiency is increased, the filter clogging phenomenon is improved, and especially for finely ground coffee beans, the extraction time is drastically reduced to the level of espresso extraction.

The coffee beverage brewing extraction apparatus according to the present disclosure has a simple structure and is easy to separate each component, so that it is easy to clean and easy to carry.

The coffee beverage brewing extraction apparatus according to the present disclosure is similar to the structure of the existing hand drip method, so it is familiar to the user and provides an effect that can adjust the coffee beverage flavor in various ways to suit individual tastes.

The coffee beverage brewing extraction apparatus according to the present disclosure is simple and inexpensive to manufacture, so that it can be spread with ease.

### BRIEF DESCRIPTION OF THE DRAWINGS

FIG. 1 is a cross-sectional view of an extractor according to the present disclosure.

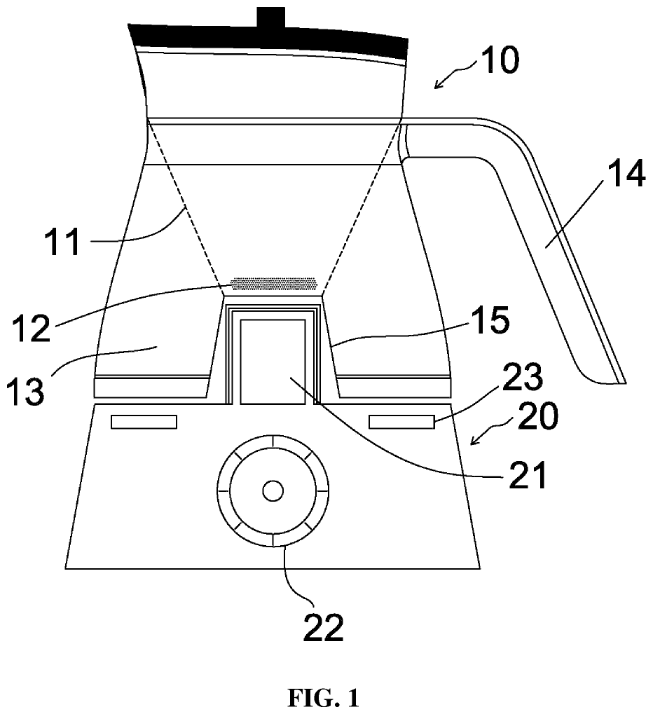

FIG. 2 is a perspective view of an undiluted solution extraction unit container.

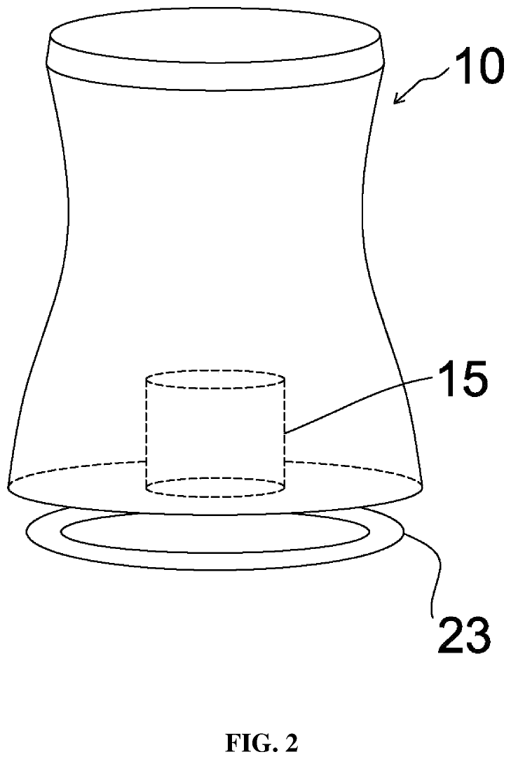

FIG. 3 is a perspective view of a dripper or a filter, a rotor, and a rotating part, which are main components of the extractor of the present disclosure.

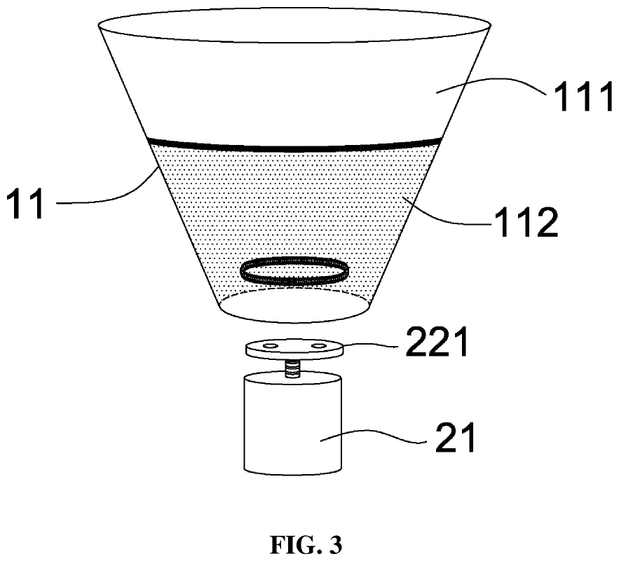

FIG. 4 is a perspective view of the dripper, which is a main component of the extractor of the present disclosure.

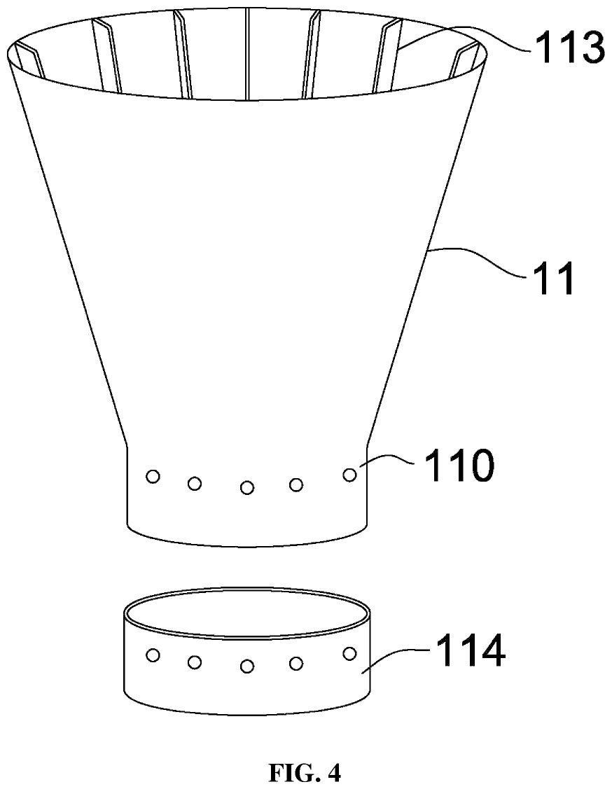

FIG. 5 is a schematic diagram showing an example of using a mixer coupling of the extractor of the present disclosure.

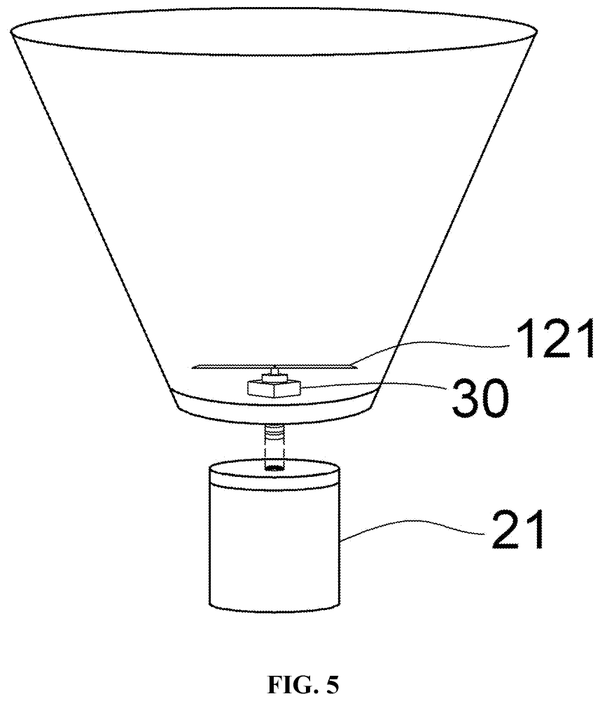

FIG. 6 is a cross-sectional view of one embodiment of the rotating part and rotor of the extractor of the present disclosure.

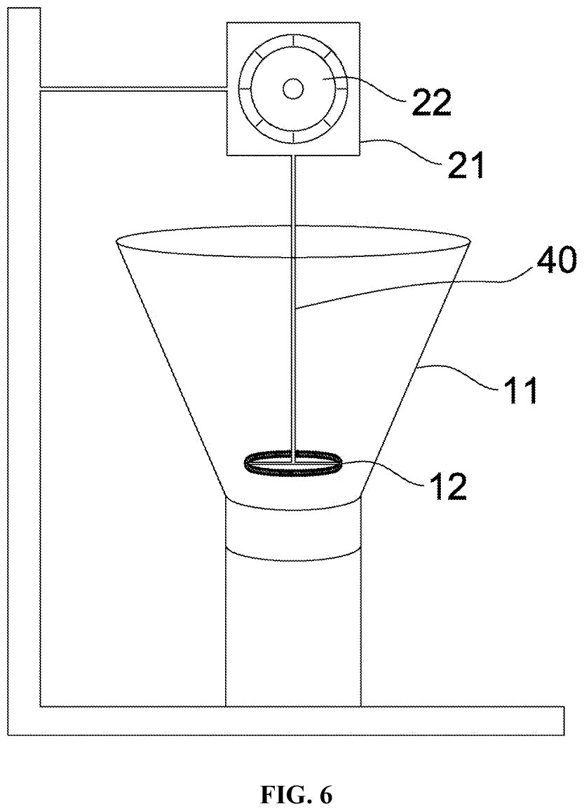

FIG. 7 is a perspective view of one embodiment of the rotating part and rotor of the extractor of the present disclosure.

FIG. 8 is a perspective view of one embodiment of the rotor driven by a handle of the extractor of the present disclosure.

FIG. 9 is a perspective view of one embodiment the rotor fixing attachment of the extractor structure of the present disclosure.

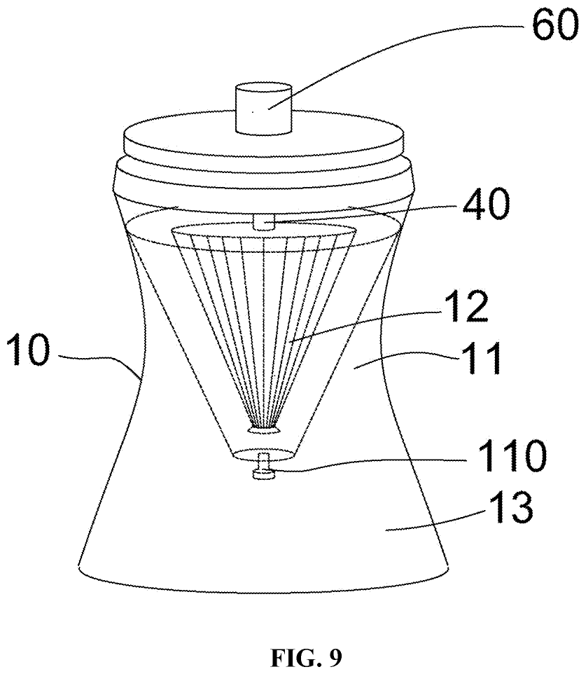

### DESCRIPTION OF EXEMPLARY EMBODIMENTS

Hereinafter, a coffee beverage brewing extraction method and apparatus using stirring force according to a preferred embodiment of the present disclosure will be described in detail with reference to the accompanying drawings.

In the extraction method according to one embodiment of the present disclosure, after a dripper 11 is seated on a coffee beverage extraction unit 10, a filter paper is closely attached and seated to an inner wall of the dripper 11.

A capacity of the dripper is 400 ml, and an area of an extraction port was adjusted such that a complete extraction time is 1 minute and 15 seconds when only 300 ml of water is poured into the dripper.

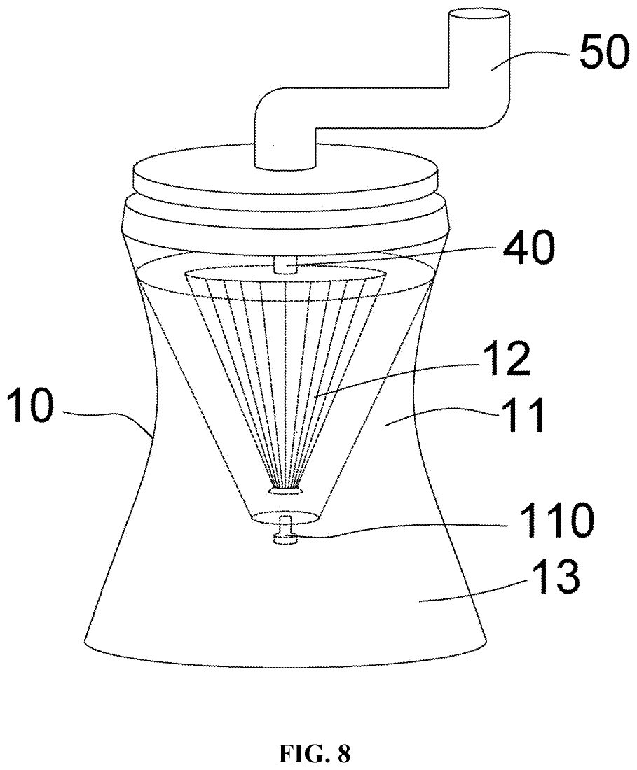

After putting 10 g of finely ground medium-roasted beans with a grinding degree of espresso 0.2 mm into the filter paper of the dripper and pouring 260 ml of hot water at 95° C. without steaming, the beans was stirred using a cone-shaped rotor with a volume of 120 cc as shown in FIG. 8 while giving strength and weakness at 15 second intervals.

The fine coffee beans remained well mixed with water, and a 200 ml of coffee beverage was extracted within 1 minute without clogging of the filter.

This is the same level in total time as espresso extraction, considering 30 seconds required for the espresso extraction and a tamping process time.

There was no clogging of the filter by expanding the filter area using the method and principle presented in the present disclosure, and the extraction speed and extraction amount were accurately controlled by the area of the extraction port. The coffee flavor was deep and good, and the amount of extraction was 1.5 times more efficient than the existing hand drip.

In another example according to the present embodiment, after the dripper 11 is seated on the coffee beverage extraction unit 10 and the filter paper is closely attached and seated to an inner wall rib 113 of the dripper 11, 10 g of coffee bean compressed blocks are put inside the dripper 11 by appropriately crushing the blocks, and then 280 ml of hot water at 95° C. in total is poured into the dripper 11.

In this case, in order to steam the coffee beans, it may be possible to pour 25 cc of hot water, wait for 20 seconds, and then pour 255 ml of hot water, but this step may be omitted.

A dripper with a capacity of 300 ml was used as the extractor, and the area of the extraction port was adjusted to the extent that when 300 ml of water is poured into the dripper, it takes 1 minute and 30 seconds for all to flow down.

After steaming and pouring hot water, when the rotor 12 is rotated at 600 rpm for 1 minute and 30 seconds, coffee beans and hot water are well mixed and stirred by water waves, so the coffee beverage is extracted through the extraction port 110 of the dripper 11 by the centrifugal force due to the rotation and the gravitational action of the hot water.

At the time when the extraction is slowed down since the filter is clogged with powders such as coffee cell walls at the end time of coffee beverage extraction, when the centrifugal force is increased by increasing the speed of the rotor 12, the extraction may be completely achieved, or when the extraction is stopped at an appropriate time while the extraction is slowed down, the flavor is deepened.

The above method may adjust the amount of coffee beans, the speed of the rotor 12, and the amount of water, the number of times of pouring water, the extraction operation time through the adjustment of the extraction port, and the like. On average, when 200 ml to 250 ml of coffee beverage is extracted from compressed blocks of a 7 mm thick formed by compressing 10 g of medium-roasted coffee beans at a pressure of 600 kg/cm², a sufficient amount of the coffee beverage having flavor was extracted.

Examining the coffee bean residue remaining in the dripper 11 after extraction, the epidermis of the coffee beans remained at an average size of 3 mm, and the cell walls of the bean honeycomb structure were broken to a size of around 0.1 mm. From this, it was found that the bad taste extracted from the smell of smoke, the smell of burnt, and the burnt resin of the fibrous portion contained in the epidermis of the beans during roasting was relatively small as the contact area of the bean epidermis with water was small. From the small structure of the honeycomb cell structure, since the total extraction time was about 2 minutes, the water-soluble coffee solids had a large area in contact with water and were sufficiently extracted, while extraction of the fibrous resin component of the cell walls was relatively less than the hand drip or leaching method due to the structure of the compressed blocks and the short extraction time.

As a result, a lot of acidity, sweetness, bitterness, and savory taste are extracted in a balanced way, so the flavor is deepened, and the impure taste such as burnt taste is greatly reduced due to little bad taste extraction. In addition, a large amount of coffee solids were extracted from the cracks of the compressed blocks and the honeycomb structure broken down by stirring, so that more than 1.5 times the average hand drip amount could be extracted.

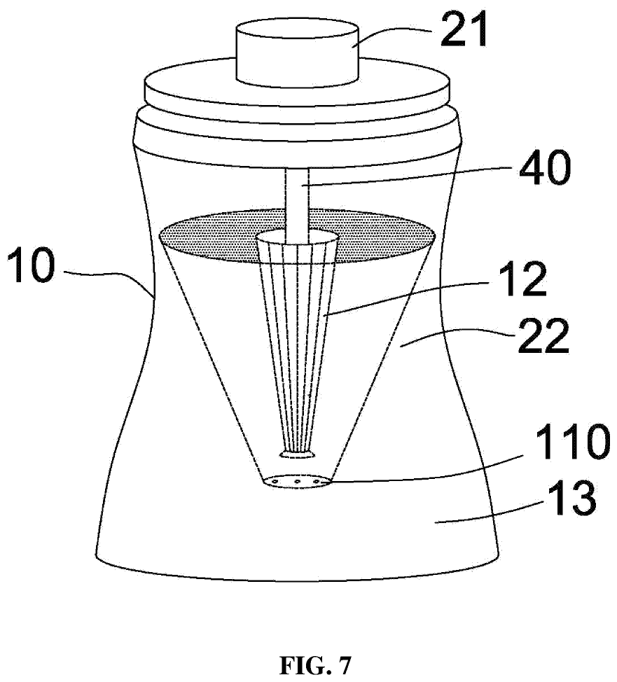

In the present disclosure, in a structure where the bottom of an undiluted solution extraction unit is flat in the undiluted solution extraction unit 10, when the coffee beverage is extracted in the manner described in the above embodiment by hanging the dripper or filter on an upper edge of the undiluted solution extraction unit and disposing the rotor in an upper portion as shown in FIG. 7, the coffee beverage was smoothly extracted by centrifugal force and gravity until a time point at which the water level of the coffee beverage extracted from the dripper or filter 11 is lower than the water level in the dripper or filter 11.

In another embodiment of the present disclosure, 15 g of medium-roasted coffee beans was finely ground to a size suitable for an espresso or mocha pot, 280 ml of hot water at 92° C. was poured into the dripper, and then 200 ml of coffee beverage was extracted through the extraction port while stirring for 1 minute without steaming.

The extracted coffee beverage was quite thick and had a good flavor when 50 ml of water was added thereto.

The natural flavor of the coffee beans was good, there was no excessive extraction such as bad taste, bitter taste, and burnt taste due to the short extraction time, and there was no filter clogging even though the coffee beans were finely ground.

In the above, the speed of the rotor is 300 rpm, the rotor having a conical shape with a small volume was used, the area of the extraction port of the dripper was adjusted such that when only 300 ml of water is poured into the dripper, the total dripping time is 40 seconds, and it took about 1 minute for the mixed solution passed through the filter to be extracted from the extractor having the structure of FIG. 7 as the coffee beans and water are stirred, and 200 ml of coffee beverage was extracted.

In still another embodiment of the present disclosure, 15 g of medium-roasted coffee beans was ground to a size of about 1.2 mm for general hand drip, steamed for 20 seconds using hot water at 95° C., and then stirred. The stirring extraction time took a total of 1 minute and 40 seconds, and 220 ml of coffee beverage was extracted.

In the above, the speed of the rotor was 450 rpm and the area of the dripper extraction port was adjusted to the extent that when only 300 ml of water is poured, it takes a total of 1 minute and 30 seconds for water to flow down.

The extracted coffee beverage became a delicious coffee having the flavor with a well-balanced and appropriate concentration.

From the above examples, it can be confirmed that the method and apparatus of the present disclosure can efficiently extract flavored coffee beverages when applied to various ground and compressed blocks by adjusting the area of the extraction port and the volume and rotation speed of the rotor.

In the present disclosure, the stirring method of the present disclosure has been described as being made by the rotor disposed in the dripper or filter, but since the stirring method may be modified and applied in various forms, the stirring method of the present disclosure may be applied in various ways, such as vibrating or rotating the dripper from the outside and applying air bubbles into the dripper.

The embodiments described above are examples, and various changes and modifications may be made by those skilled in the art to which the present disclosure pertains within the scope not departing from the essential characteristics of the present disclosure.

Accordingly, the embodiments disclosed in the present disclosure are intended not to limit, but to explain, the technical idea of the present disclosure, and the scope of the technical idea of the present disclosure is not limited by these embodiments.

The protection scope of the present disclosure should be construed according to the following claims, and all technical ideas within the equivalent range should be construed as being included in the scope of the present disclosure.

1. A coffee beverage brewing extraction method for extracting a coffee beverage using a hot water brewing method, the coffee beverage brewing extraction method comprising:
maintaining a rate at which a coffee beverage is extracted from a mixed solution of coffee beans and hot water in a dripper or a filter through an extraction port of the dripper or filter holes for a certain period of time in order to expand an extraction area where the dripper or a filter surface of the filter and a mixed solution of coffee beans and hot water contact each other while coffee is being extracted to secure an extraction area where the mixed solution comes into contact with the dripper or the filter surface of the filter; and
stirring the mixed solution in a state in which a level of the mixed solution is raised by a volume of a rotor disposed inside the dripper or the filter and submerged in the mixed solution to further expand the extraction area to extract the coffee beverage from the dripper or the filter.

2. The coffee beverage brewing extraction method of claim 1, wherein a standard extraction time for extraction from the extraction port of the dripper or the filter is set such that when only water is poured into the dripper or the filter having a capacity of 300 ml, a time taken when the water completely flows down through the extraction port of the dripper or the filter is typically 1 minute to 2 minutes and 30 seconds, and an extraction time is set by setting an area of the extraction port of the dripper or a size and arrangement of the filter holes of the filter to allow the standard extraction time to be shorter or longer depending on a change of the capacity of the dripper or the filter or a thickness of ground beans.

3. The coffee beverage brewing extraction method of claim 1, wherein the volume of the rotor is determined so that a volume of the rotor submerged in the mixed solution is 30% or more of a volume of the mixed solution.

4. The coffee beverage brewing extraction method of claim 1, wherein stirring force by the rotor is generated by a rotational force of a handwheel or a motor.

5. The coffee beverage brewing extraction method of claim 1, wherein stirring force by the rotor is generated by gravity or external force applied to a narrowed space between an outer surface of the rotor and a filter wall surface in a state where the rotor is not rotated but fixed in the mixed solution.

6. A coffee beverage brewing extraction apparatus for extracting a coffee beverage using a hot water brewing method, the apparatus comprising:
a dripper or a filter having an extraction port or filter holes for maintaining a rate at which a coffee beverage is extracted from a mixed solution of coffee beans and hot water in the dripper or the filter through the extraction port or the filter holes for a certain period of time in order to expand an extraction area where the dripper or a filter surface of the filter and the mixed solution of coffee beans and hot water contact each other while coffee is being extracted to secure an area where the mixed solution comes into contact with the dripper or the filter surface of the filter; and
a rotor that raises a level of the mixed solution by a volume of the rotor disposed inside the dripper or the filter and submerged in the mixed solution to further expand the extraction area and stirs the mixed solution.

7. The coffee beverage brewing extraction apparatus of claim 6, wherein a standard extraction time for extraction from the extraction port of the dripper or the filter is set such that when only water is poured into the dripper or the filter having a capacity of 300 ml, a time taken when the water completely flows down through the extraction port of the dripper or the filter is typically 1 minute to 2 minutes and 30 seconds, and an extraction time is set by setting an area of the extraction port of the dripper or a size and arrangement of the filter holes of the filter to allow the standard extraction time to be shorter or longer depending on a change of the capacity of the dripper or the filter or a thickness of ground beans.

8. The coffee beverage brewing extraction apparatus of claim 6, wherein the volume of the rotor is determined so that a volume of the rotor submerged in the mixed solution is 30% or more of a volume of the mixed solution.

9. The coffee beverage brewing extraction apparatus of claim 6, wherein stirring force by the rotor is generated by using at least one of a rotational force by a self-stirring rotation method through a handwheel or a motor, and a rotational force by a rotation transmission method through a rotation shaft.

10. The coffee beverage brewing extraction apparatus of claim 6, wherein the rotor is configured not to be rotated but to be fixed in the dripper or the filter.

11. The coffee beverage brewing extraction apparatus of claim 6, wherein the extraction port installed in the dripper is provided with an adjuster for adjusting an area of the extraction port.

12. The coffee beverage brewing extraction apparatus of claim 9, further comprising a rotation adjuster for adjusting a rotation speed of the rotor.

13. The coffee beverage brewing extraction apparatus of claim 6, wherein the dripper has a vacuum structure or a heating wire disposed between an inner wall and an outer wall thereof so that the dripper has a warming function.
